(19) United States
(12) Patent Application Publication
(10) Pub. No.: US 2016/0136598 A1
(43) Pub. Date: May 19, 2016

(54) ULTRASONIC SYSTEM FOR MIXING MULTIPHASE MEDIA AND LIQUIDS, AND ASSOCIATED METHOD

(71) Applicant: PUSONICS S.L., Arganda del Rey (Madrid) (ES)

(72) Inventor: Andrea CARDONI, Madrid (ES)

(73) Assignee: PUSONICS S.L., Madrid (ES)

(21) Appl. No.: 14/902,282

(22) PCT Filed: Jul. 3, 2013
(86) PCT No.: PCT/ES2013/070466

§ 371 Date: Dec. 30, 2015

(51) Int. Cl. B01F 11/02

(52) U.S. Cl. CPC B01F 11/02

(57) ABSTRACT

The invention describes an ultrasonic device primarily intended for sonication of liquid and multiphase-media (gas-liquid, solid-liquid) through flexural vibration of tuned blades. The ultrasonic system comprises a source of alternating electrical field, an electro-acoustic transducer connected to the source of alternating electrical field, a booster connected to the electro-acoustic transducer with a cross section distal to the electro-acoustic transducer smaller than a cross section proximal to the electro-acoustic transducer, and at least one tuned blade coupled to the booster, wherein the at least one blade couple flexural vibrations to the liquid or multiphasic media. The system allows the treatment of larger volumes of fluid media compared with conventional longitudinally resonant ultrasonic devices characterized by small radiating surfaces. The flexural motion of the tuned blades may be achieved through the use of an electro-acoustic transducer operated in a torsional mode of vibration, or via a sub-assembly excited in a torsional-longitudinal composite mode.

### OBJECT OF THE INVENTION

The present invention belongs to the field of Sonochemistry, a branch of chemistry which exploits sound energy to affect chemical and physical processes.

The invention relates to an ultrasonic system for mixing liquids and multiphasic media, and a method.

### BACKGROUND OF THE INVENTION

The potentials of sonochemistry were first identified by Loomis during the 1920s. Sonic waves of great intensity generated in liquids were found to produce cavitational effects leading to “clear accelerating effects” e.g., explosion of NI3, and “atomization” of glass fragments from container walls.

The application of ultrasonic vibrations to produce radical polymerization initiation by means of acoustic cavitation was introduced by A. S. Ostroski and R. B. Stambaugh in 1950 [Ostroski, A. S., and Stambaugh, R. B., “Emulsion Polymerization with Ultrasonic Vibration”, J. Appl. Phys. 21, pp. 478 (1950)]. These scientists found that applying power ultrasound to a monomer (for example styrene) emulsion in an aqueous medium produced a better dispersion, which also significantly accelerated the rate of styrene polymerization.

Over the last few decades a range of ultrasonic devices and processes have been introduced to enhance various laboratory and industrial processes including homogenization, emulsification, degassing, crystallization, solid particle reductions, and the enhancement of chemical reactions. In biology and biochemistry acoustic cavitation has been shown causing the rupture of biological cell walls and isolating cell contents [Gogate, P. R.; Kabadi, A. M. “A review of applications of cavitation in biochemical engineering/biotechnology”. Biochemical Engineering Journal, 44 (1), pp. 60-72, 2009]. In particular it has been shown that enzymatic transformations may be achieved through the release of selected cell contents by ultrasound.

Most of the conventional ultrasonic devices used to propagate sound energy in liquids and multiphasic media exploit the longitudinal vibrations excited in a semi-immersed tuned horn by an electro-acoustic transducer. Longitudinally tuned horns may incorporate cylindrical, stepped, conical or exponential profiles. Tapered horn geometries are required to amplify the, otherwise, limited longitudinal oscillatory motion of the transducer, thus delivering sufficient energy to create cavitation in the medium. A vibration amplitude amplifier, known as booster, might also be placed between the transducer and tuned horn to magnify transducer oscillations [Romdhane, M., Gourdon, C., “Investigation in solid-liquid extraction: influence of ultrasound” Chemical Engineering Journal, 87(1), pp 11-19, 2002].

Acoustic cavitation consists in the creation (and subsequent collapse) of pulsating bubbles through the propagation of sound waves at intensities above a specific applied power threshold, depending on the treated medium. Extremely high local temperatures and pressures result from bubble implosions which give rise to shear forces associated with cavitatory effects such as shock waves, acoustic streaming, and micro-jets. These phenomena have been shown to be responsible for significantly improving mixing processes as well as producing/enhancing chemical reactions.

The main problem with conventional longitudinally vibrating ultrasonic devices is that these are able to effectively ‘sonicate’ only a small volume of the processed medium in the vicinity of the horn tip. As a result, the spectacular effects of power ultrasound in liquids reported in the literature may, normally, be observed and reproduced only at laboratory scale level, where treated product volumes are small.

The principal components of a conventional ultrasonic system for sonochemical applications are shown in FIG. 1 wherein a conventional electro-acoustic transducer 1 that receives an alternating electrical field from an ultrasonic generator 2 produces a longitudinal vibration. Transducer vibration is transferred to attached booster 3 and then coupled to operating member, horn 4. Both booster 3 and horn 4 are tuned to resonate in a longitudinal mode. The tip of the horn is immersed in a liquid or multiphasic fluid 6 contained in reactor 7, with the purpose of producing acoustic cavitation. Since in this prior art configuration the tip output face is the only active part of the horn just a small amount of fluid can be actually processed. Such a restriction is the main cause behind present difficulties to scale up sonochemical applications.

For scaled-up applications where larger product volumes are processed a series of longitudinally vibrating systems may be used. However such an arrangement may result impractical and expensive. In order to overcome the limitations of conventional ultrasonic devices new system configurations have been recently proposed. Gallego-Juarez et al. have developed a family of flexurally vibrating plates activated via longitudinally resonating piezoelectric vibrators (EP 1010796 B1). These radiating plates are capable of producing cavitation over a larger amount of treated medium compared with conventional longitudinal systems. Such devices have been investigated in textile washing as well as in pigment size reductions during paint preparation processes.

The company Sodeva developed a tuned assembly configuration consisting in a tube-like horn excited by a transducer perpendicular to the horn (EP 1372809 B1). The horn vibrates in a flexural mode of vibration and is capable of sonicating larger amounts of fluids in both batch and continuous operations. A hollow horn with enhanced emitting surface was launched by Telsonic (U.S. Pat. No. 4,537,511). Within this specially designed tuned tool, part of the longitudinal oscillation is converted into radial motion allowing the exploitation of the horn lateral surface as radiating area.

Pandit et al. have developed a sonochemical reactor with a hexagonal cross-section where rows of Langevin transducers are attached on the reactor sides. This design has been shown as a candidate for scaled up applications such as KI dosimetry and degradation of a reactive dye, Rhodamine B. Hodnett et al. have proposed a similar reactor with a circular section and multiple attached transducers (EP 1509301 B1). The system has been used in crystallization processes for the manufacturing of pharmaceuticals. Both multiple-transducer system configurations can be operated at different frequencies in order to obtain a more uniform cavitational field.

Ultimately, in order to enhance mixing effects, longitudinally vibrating ultrasonic devices have been used in conjunction with mechanical stirrers [U.S. Pat. No. 5,484,573]. The addition of ultrasound to mechanical stirring appeared to increase liquid-liquid reactions' rates such as in the preparation of zinc sulfide based electroluminescent phosphors [U.S.20040007692]. However, the introduction of a stirrer and ultrasonic horn in a flask or a tank may be complicated.

For all the reasons stated above there is now a need for the development of compact ultrasonic devices capable of efficiently sonicating larger product volumes thus enhancing mixing and sonochemical processes. There is also a requirement to introduce reconfigurable systems adaptable to a variety of processes. The invention described herein addresses all these and other needs.

### SUMMARY OF THE INVENTION

The present invention overcomes the above problems by the provision of an ultrasonic system according to claim 1 and a method for ultrasonic processing according to claim 17. The dependent claims define preferred embodiments of the invention.

The invention described herein introduces a novel family of ultrasonic assemblies constituted by torsional, or longitudinal-torsional, sub-assemblies coupled to flexurally resonating blades. Such composite mode ultrasonic devices may allow the efficient propagation of acoustic waves through larger volumes of treatment media compared with conventional longitudinal-type ultrasonic devices. This achievement may be accomplished through the flexural oscillations of tuned blades that create multiple cavitation zones in the processed product. Besides, the acoustic streaming generated within the treatment fluid by blade vibratory motions may result in additional beneficial effects.

Thus, in a first aspect of the invention, it is presented an ultrasonic system for liquid and multiphasic media processing that comprises:
i) A source of alternating electrical field,
ii) An electro-acoustic transducer connected to the source of alternating electrical field;
iii) A booster connected to the electro-acoustic transducer with a cross section distal to the electro-acoustic transducer smaller than a cross section proximal to the electro-acoustic transducer; and
iv) At least one tuned blade coupled to the booster, wherein the at least one blade couple flexural vibrations to the liquid or multiphasic media.

Advantageously, the ultrasonic system comprises a horn having a tip, the horn being coupled to the distal end of the booster and the tip of the horn being coupled to the at least one blade.

The mixing effects generated through this system, that is to say, the electro-acoustic transducer, transmitting components, and tuned blades immersed in the treated medium may be advantageously improved applying a motor driven rotation to the tuned system. Rotary motor introduction results in a synergetic combination of shear forces produced by both rotational motion and ultrasonic vibrations of the blades in the processed medium.

In an advantageous embodiment the torsional or longitudinal-torsional oscillations, required to excite flexural oscillations of the blades, are generated by the incorporation of piezoelectric elements polarized in the circumferential direction within the transducer. Alternatively, inhomogeneous transmitting tuned components, such a booster and/or horn, coupled to a longitudinally vibrating electro-acoustic transducer produce the torsional or longitudinal-torsional oscillation at the horn and/or booster tip required to excite the blades flexurally.

A second aspect of the invention presents a method for ultrasonic processing of liquid and multiphasic media contained in a reactor that comprises the steps of:
i) Providing an ultrasonic system according to the first aspect of the invention,
ii) Locate the at least one blade of the system in the reactor, and
iii) Actuate the ultrasonic system by applying an alternating electrical field to the electro-acoustic transducer.

All the features described in this specification (including the claims, description and drawings) and/or all the steps of the described method can be combined in any combination, with the exception of combinations of such mutually exclusive features and/or steps.

### BRIEF DESCRIPTION OF THE DRAWINGS

These and other features and advantages of the invention will be seen more clearly from the following detailed description of a preferred embodiment provided only by way of illustrative and non-limiting example in reference to the attached drawings.

FIG. 1 This figure is an illustration of a prior art ultrasonic system for sonochemistry made up of an electroacoustic transducer, a booster and a horn all tuned to resonate in a longitudinal mode of vibration.

FIG. 2 This figure shows a torsional-flexural composite mode ultrasonic device for liquid and multiphasic media processing in accordance with the embodiments of the present invention, wherein the torsional vibration component is excited by circumferentially polarized piezoelectric ceramics and used to excite two attached tuned blades in a flexural mode.

FIG. 2A This figure illustrates a connection configuration between the motor driven shaft with the ultrasonic torsional transducer.

FIG. 3 This figure, through 3D, shows the first four flexural modal shapes of the tuned blades excited by the torsional vibration of the horn, calculated by Finite Element Analysis.

FIG. 4 This figure is a view of an alternative embodiment of the invention wherein four flexurally vibrating blades are activated by the torsional motion of the horn.

FIG. 5A This figure is a view of two flexurally vibrating blades with an alternative geometry consisting in a step change of the cross section, activated by torsional excitation.

FIG. 5B This figure is a view of another configuration of the invention wherein mixing is produced by the rotation of a rotor made up of tuned blades vibrating flexurally, inserted in a co-axial stator incorporating diagonal slits. For figure clarity rotor and stator are illustrated separately.

FIG. 6 This figure shows a manufactured sub-assembly comprising a transducer with circumferentially polarized piezoelectric elements, a booster and a horn, tuned in the third torsional mode when driven at around 29 kHz.

FIGS. 7A-7C These figures show three assembly configurations, consisting in three alternative flexural blade pairs mounted on the same torsionally vibrating sub-assembly.

FIGS. 8A-8C These figures illustrate parallel powder lines forming on the planes of the blades' configurations shown in FIG. 7 in correspondence of flexural nodes.

FIGS. 9A-9B These figures illustrate a front and a top view of the submerged blades highlighting the cavitational effects produced in water in the form of cavitating bubble clouds near the flexural anti-nodes of the blades along with acoustic streamlines.

FIG. 10 This figure is a torsional-flexural composite mode ultrasonic device for liquid and multiphasic media processing in accordance with the embodiments of the present invention, wherein the torsional vibration component excited by circumferentially polarized piezoelectric ceramics is used to excite a plurality of tuned blades connected at the torsional anti-nodes of a one-wavelength long tuned horn.

FIG. 11A This figure shows a possible mechanical connection between interchangeable blades and the horn using a groove joint.

FIG. 11B This figure shows another possible mechanical connection between interchangeable blades and the horn where two groove joints are incorporated.

FIG. 12 This figure is a longitudinal-torsional-flexural composite mode ultrasonic device for liquid and multiphasic media processing in accordance with the embodiments of the present invention, wherein the longitudinal-torsional composite vibration is obtained by the incorporation of diagonal slits in the horn.

FIG. 12A This figure is a schematic drawing showing the deflection angle a between one slit and the longitudinal axis of the ultrasonic device.

FIG. 13 This figure shows a configuration of the tuned blades wherein they are welded at an angle of 45 degrees with respect to the horn axis in a pitched blade turbine configuration.

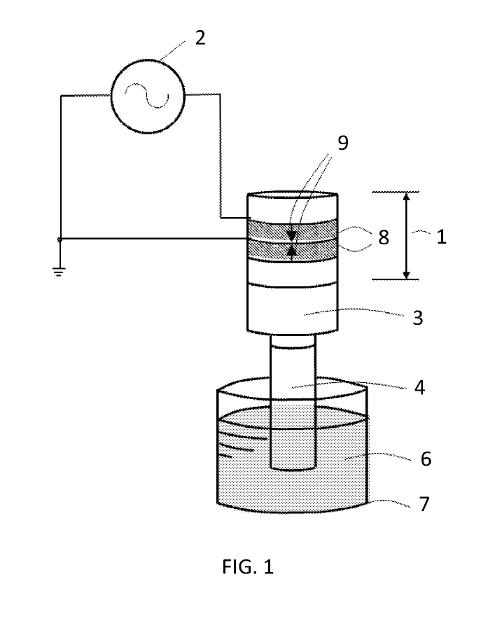

### DETAILED DESCRIPTION OF THE INVENTION

The invention is directed to ultrasonic systems designed to operate in liquid and multiphasic media by means of flexurally vibrating blades excited by a mechanically coupled subassembly comprising an electro-acoustic transducer and transmitting components, tuned in a torsional or longitudinal-torsional mode of vibration.

In a first embodiment of the present invention an electro-acoustic torsional transducer 1′ that receives an alternating electrical field from an ultrasonic generator 2′ produces a torsional vibration within the transducer which is transferred to coupled booster 3′.

Tuned blades 5 are attached to the booster 3′ and immersed in a liquid or multiphasic fluid 6 contained in reactor 7 for the purpose of producing multiple cavitation zones.

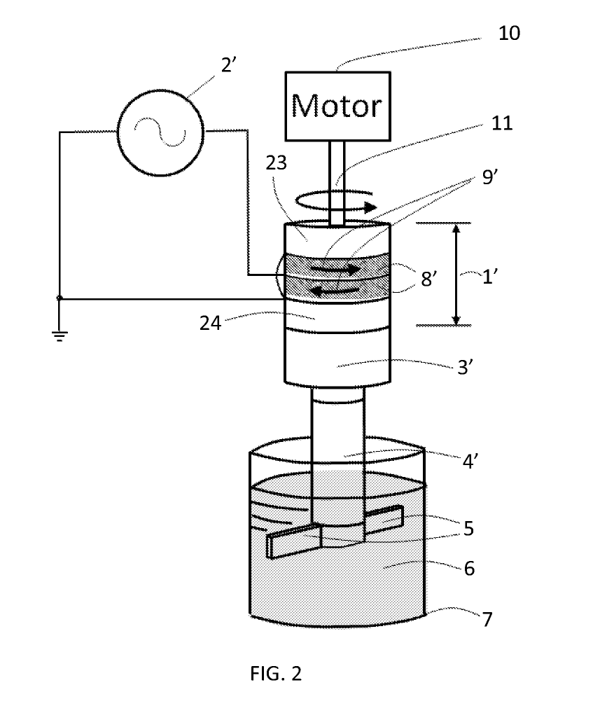

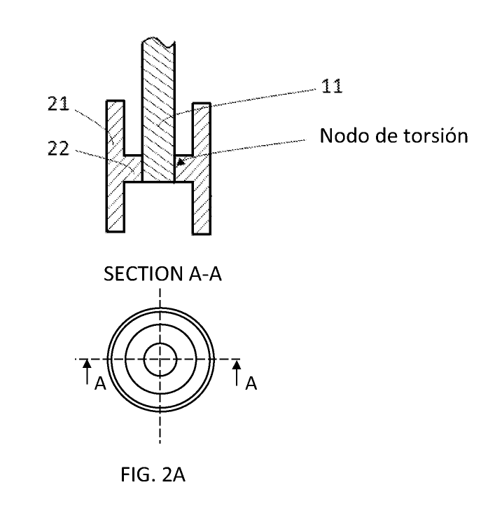

A second embodiment of the present invention is shown in FIG. 2. In this figure, an electro-acoustic torsional transducer 1′ that receives an alternating electrical field from an ultrasonic generator 2′ produces a torsional vibration within the transducer which is transferred to coupled booster 3′ and then to horn 4′. Tuned blades 5 are attached to the distal end of the horn (horn tip) and immersed in a liquid or multiphasic fluid 6 contained in reactor 7 for the purpose of producing multiple cavitation zones.

In a particular embodiment, the electro-mechanical transducer 1′ comprises a plurality of piezoelectric elements. More specifically, the transducer incorporates two piezoelectric elements sandwiched between two metal components: first end-mass 23 and second end-mass 24. Piezoelectric elements 8′ are polarized circumferentially and positioned so that the polarization vectors 9′ result in opposite directions. This configuration of the piezoelectric elements is employed to generate torsional motion in response to the supply of alternating electrical field. Booster 3′ is a metal component typically designed such that its cross section distal to the transducer 1′ is smaller than the cross section proximal to the transducer 1′. As illustrated, Booster 3′ has a stepped profile but other profiles such as exponential, conical, cantenoidal could be used to amplify the limited torsional output of transducer 1′. Advantageously booster 3′ and horn 4′, also a metal component, have tuned lengths equal to integer multiples of the torsional half-wavelength.

Still referring to FIG. 2, two blades 5 are coupled to the distal end of horn 4′ in a straight blade turbine configuration in order that each blade plane contains the longitudinal axis of the horn 4′. The attached blades 5 vibrate in a flexural mode of vibration under the torsional motion produced by the horn 4′.

In a preferred embodiment, in combination to the flexural vibratory motion of the tuned blades 5 a motor 10 driven rotation of the ultrasonic system may be applied to enhance mixing performance. The motor 10, which could be of the electromagnetic type, freely rotates the full-assembly comprising the ultrasonic transducer 1′ together with the transmitting members (booster 3′ and horn 4′) and flexural blades 5. Rotation is transferred to the ultrasonic system via shaft 11 which is coupled to the nodal section of the torsional transducer 1′. FIG. 2A illustrates threaded stud 21 which is used to pre-compress the piezoelectric elements 8′ between first end-mass 23 and second end-mass 24. Stud 21 is a hollow member with an inwardly projecting flange 22 corresponding to a torsional vibration nodal region. Shaft 11 is coupled to flange 22 so as to avoid suppression of the ultrasonic vibration whilst transferring motor driven rotation to the tuned device.

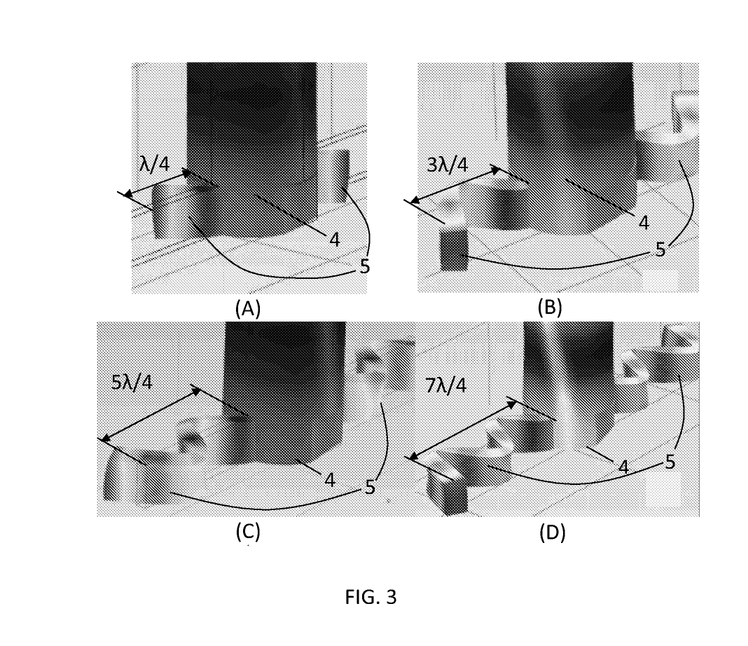

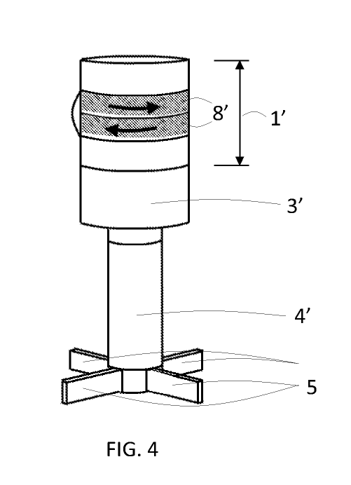

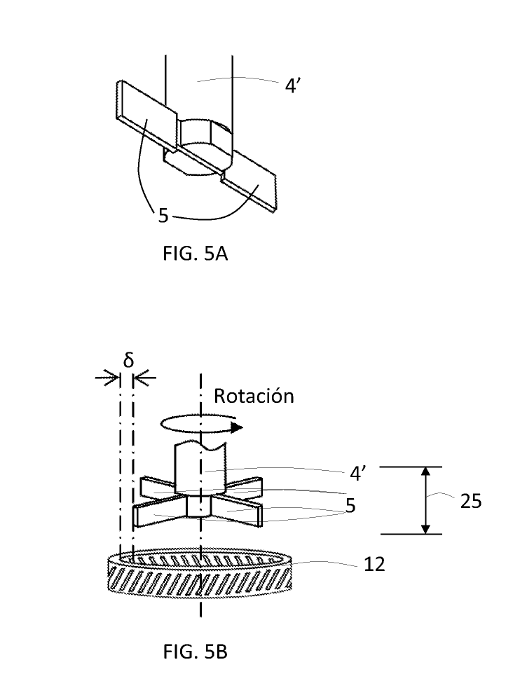

Blades 5 behave like cantilever beams resonating in a specific flexural harmonic according to their tuned length, as shown in FIG. 3. In the figure blades pairs resonating in the first, second, third, and fourth flexural mode at the same frequency are shown. The number of flexural blades 5 can also vary as well as their geometry. FIG. 4 shows a system configuration with four tuned blades 5 attached to the horn 4′. An alternative blade geometry activated by torsional excitation is illustrated in FIG. 5A wherein two flexurally vibrating blades 5 with a step change in the cross section are shown. Tuned blade geometries may resemble those of conventional hydrodynamic impellers. Additionally, vibrating blades 5 may be used in a rotor-stator mixer configuration, as shown in FIG. 5B. In FIG. 5B stator 12 and rotor 25 with coupled flexurally vibrating blades 5 are represented separately for clarity.

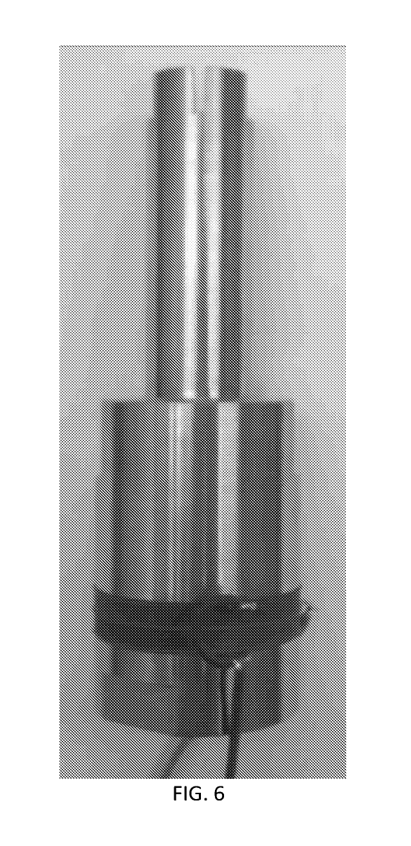

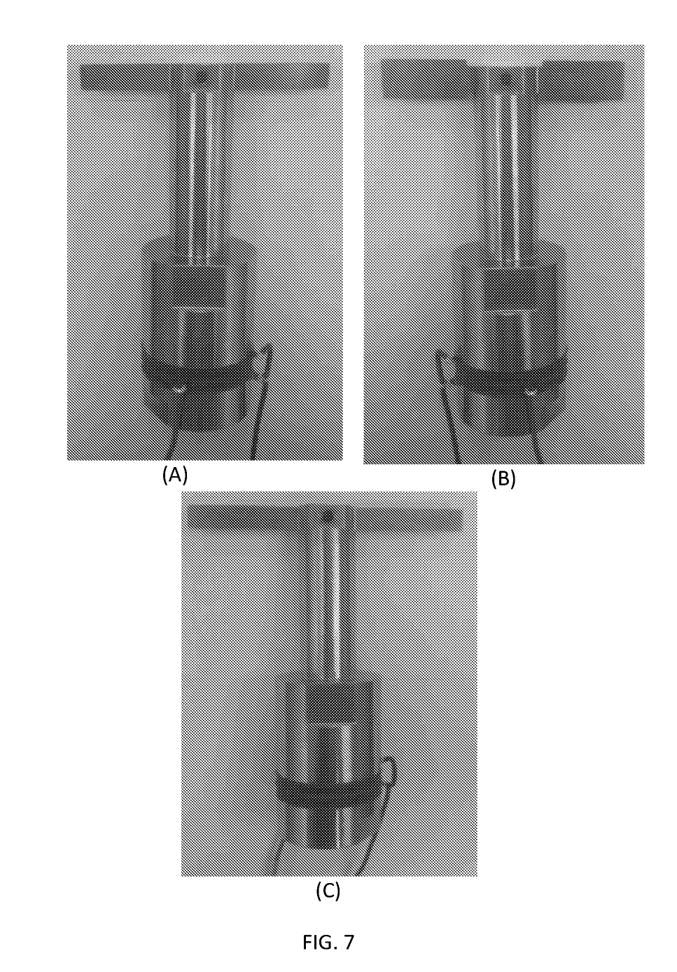

FIG. 6 shows a manufactured sub-assembly comprising a transducer with circumferentially polarized piezoelectric elements, a booster and a horn, tuned in the third torsional mode when driven at around 29 kHz. In this case booster and horn where manufactured from one piece of metal. Three blade pair configurations were also manufactured so that each pair could be alternatively mounted at the horn tip and excited in a flexural mode at a frequency near the torsional modal frequency of the driving sub-assembly. In particular, the blade pairs forming the tuned assemblies shown in FIG. 7A and FIG. 7B were dimensioned so that each blade could resonate in the third flexural mode. The length of the blades 5 illustrated in the assembly of FIG. 7C was selected one (flexural) half-wavelength longer than in the other two configurations, with the aim of responding in the fourth flexural mode at the same system tuned frequency.

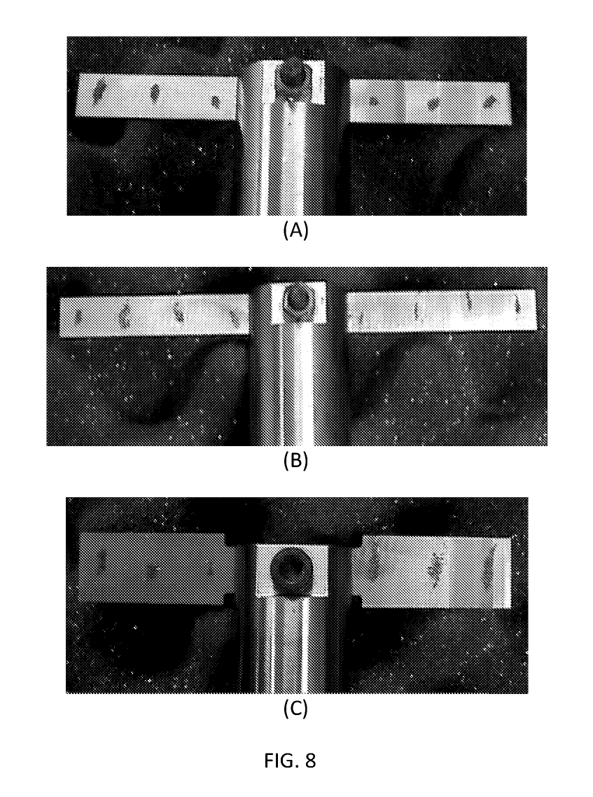

In order to visually appreciate the flexural vibration modes of the blades 5 excited through the torsional movement of the horn tip, fine metallic powder was deposited on their planes. Each of the three assembly configurations shown in FIG. 7 was driven in the frequency region of the tuned frequency through a sinusoidal excitation of 50 Vᵣₘₛ created by a function generator (Agilent 33220A) and amplified via a signal amplifier (QSC RMX 4050 HD). When the excitation frequency neared the tuned resonance of the system, parallel powder lines immediately formed on blades' planes in correspondence of the flexural nodal lines, as illustrated in FIG. 8A through 8C. The tuned frequencies of the three system configurations driven in air were all in the 28-28.5 kHz frequency range.

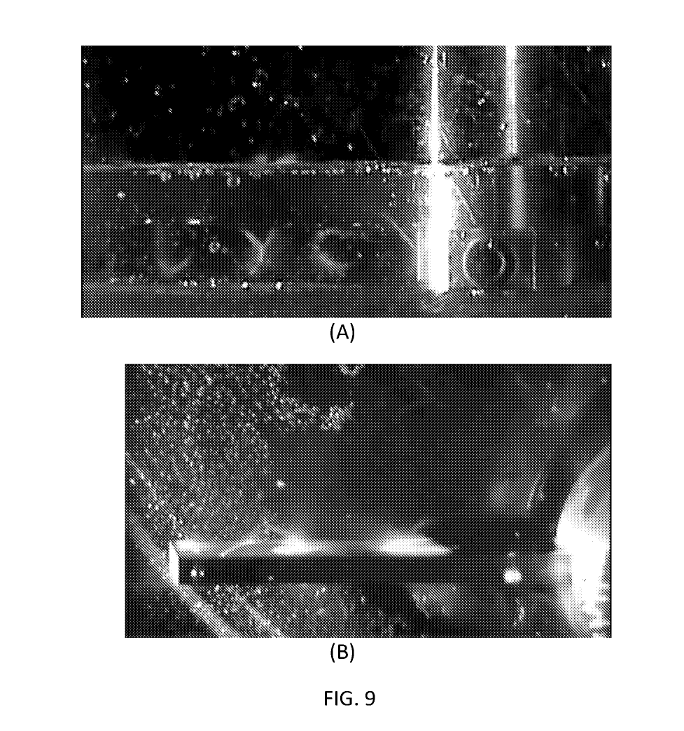

Ultimately, the blades 5 of the systems illustrated in FIG. 7C were immersed in a vessel with water and activated at a driving power in the range of 50-100 W in order to produce cavitation. It was observed that the frequency of the assembly dropped of about 0.5 kHz when the blades were completely submerged. The cavitational effects produced in water at 150 W are highlighted in FIG. 9A and FIG. 9B where cavitating bubble clouds, mainly corresponding to the flexural anti-nodes of the blades, along with acoustic streamlines may be seen. As evident from the figures multiple cavitation zones can be obtained through the application of the invention.

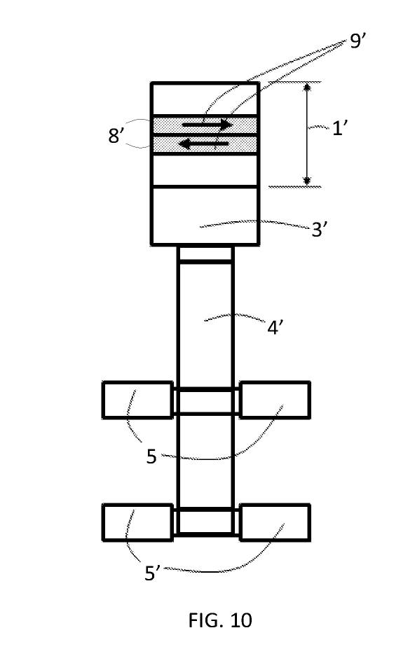

In yet another embodiment of the present invention a torsionally tuned horn 4′ can be made several half-wavelengths long in order that a plurality of tuned blades may be connected together at the horn torsional anti-nodes, as shown in FIG. 10. Advantageously horn 4′ is a one wavelength long element.

Different attachment configurations of the tuned blades 5 to the horn 4′ can be adopted. Blades 5 and horn 4′ may be machined from one piece of metal, or they may be welded to the horn. Also, in relation to the first embodiment presented, blades 5 and booster 3′ may be machined from one piece of metal, or they may be welded to the booster 3′.

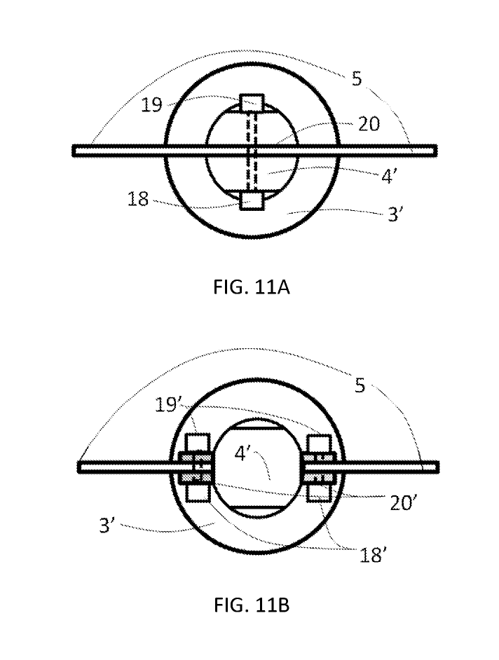

Alternatively a groove joint 20 is made at the horn tip wherein a beam is inserted and fixed by a bolt 18 and a nut 19, thus resulting in a two-bladed configuration (FIG. 11A). Another configuration wherein blades are coupled to the horn via groove joints 20′ machined at the horn rims and fixed by bolts 18′ and nuts 19′ is shown in FIG. 11B. Blade/horn attachment configurations shown in FIG. 11A and FIG. 11B allow the use of interchangeable blades. Also, in relation to the first embodiment presented, blades 5′ are coupled to the booster 3′ via at least one groove joint machined at the booster tip. Other attachment configurations may be adopted without departing from the spirit of the invention.

Torsional motion of the horn may also be obtained through the incorporation of a booster with inhomogeneous cross-sections mechanically coupled to a conventional longitudinal electro-acoustic transducer. This idea of converting pure longitudinal motion into longitudinal-torsional (L-T) vibration by means of opportune geometrical modifications of resonant rods is described in the book “Sources of High-intensity Ultrasound”, Volume 2, written by A. M. Mitskevich and edited by Rozenberg in 1969. Mitskevich improved ultrasonic welding exploiting the L-T motion obtained at the working end of a rod-system driven by a longitudinal electro-acoustic transducer by virtue of a certain inhomogeneity in the cross section of the rod.

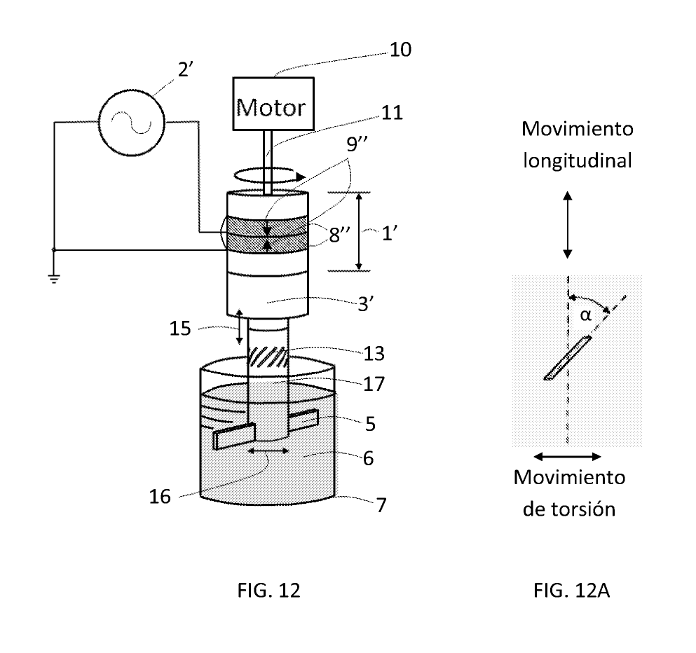

Hence, a further embodiment of the present invention, illustrated in FIG. 12, uses Mitskevich idea of introducing a geometrical inhomogeneity in a transmission member to produce the L-T motion at the horn tip where flexural blades 5 are connected.

Inhomogeneous cross-sections necessary to produce L-T motion can be achieved in various manners, for instance by means of a helical spiral configuration, or via the incorporation of diagonal slits in the booster and/or horn parts. In a further particular embodiment, not shown in the figures, the inhomogeneous booster is a spiral tapered rod, or a tapered rod with a number of diagonal slits. The obtained L-T motion is used to excite the attached flexural blades.

Referring to FIG. 12, a conventional electro-acoustic transducer 1 produces in response to the application of the alternating electrical field from the ultrasonic generator 2′ a longitudinal motion that is amplified via the attached booster 3′. Pure longitudinal motion 15 is then converted into the longitudinal-torsional vibration at the distal end 16 of the L-T horn 17. The L-T horn 17 incorporated an inhomogeneous portion to produce a torsional component of motion comparable to the longitudinal component. Advantageously, such an inhomogeneity consists in the insertion of diagonal slits 13 in the horn 17. The use of a helical spiral, or drill-like profile configuration of the horn would also result in a L-T composite motion at the tip.

The ratio of the magnitude of the longitudinal-torsional vibration 16 to the longitudinal vibration 15 depends on the amount of inhomogeneity within the horn, specifically the torsional component of motion increases with the slit depth, size, number, deflection angle a, as well as the vicinity of torsional and longitudinal modal frequencies. The deflection angle a between one slit and the longitudinal axis of the ultrasonic device is shown in FIG. 12A. For a smaller than 45° the torsional component of motion is lower than the longitudinal component. Likewise, for a greater than 45° the torsional component of motion is larger than the longitudinal component.

The torsional motion available at the horn tip may be used to excite the attached blades 5 in a flexural modal harmonic. Also in this embodiment the flexural vibratory motion of the tuned blades 5 may be combined with motor 10 driven rotation to enhance mixing performance. Rotation is transferred to the ultrasonic system through shaft 11. Shaft 11 may be coupled to transducer 1′ at a longitudinal nodal section so as to avoid suppression of the ultrasonic vibration whilst transferring motor driven rotation to the tuned device.

Also in this embodiment different attachment configurations of the tuned blades 5 to the horn 17 can be adopted. Advantageously blades 5 and horn 17 are machined from one piece of metal, or they may be welded to the horn; alternatively groove joints may be used to fix blades to the horn as shown in FIG. 11A and 11B.

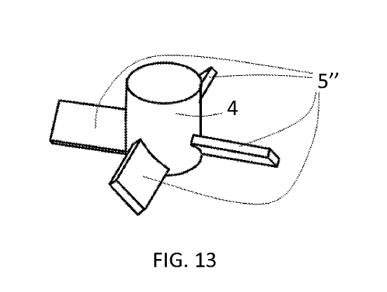

In certain mixing applications the blades may be mounted diagonally respect to the system axis in a pitched blade turbine configuration. This option is illustrated in FIG. 13. In this case both torsional and longitudinal vibration components are used to excite the tuned blades 5′ in a flexural mode. Specifically the required ratio of these vibration components depends on the established mounting angle of the blades as well as on the geometrical inhomogeneity of the horn.

In a further embodiment, in combination to the flexural vibratory motion of the tuned blades 5, 5′ of the previous embodiments, a motor 10 driven rotation of the ultrasonic system is applied to enhance mixing performance.

In any of the embodiments described, an equivalent configuration to the electro-acoustic transducer and the booster connected to such electro-acoustic transducer would be a configuration with only an electro-acoustic transducer capable of producing enough torsional oscillatory motion to excite flexurally at the least one blade coupled to its distal end, thus creating cavitation in the liquid or multiphasic medium contained in the reactor.

Many variations in the design of the torsional-flexural and longitudinal-torsional-flexural composite mode ultrasonic devices described herein are possible, including changes in the component materials and geometries all known to persons skilled in the art. Such variations may be made without departure from the scope or spirit of the invention.

In the system configuration described herein all metal components were manufactured from Ti 6Al 4V titanium alloy. Alternative metal components for component manufacture include aluminium alloy, stainless steel, beryllium copper and brass.

1. An ultrasonic system for liquid and multiphasic media processing comprising:
a source of alternating electrical field;
an electro-acoustic transducer connected to the source of alternating electrical field;
a booster connected to the electro-acoustic transducer with a cross section distal to the electro-acoustic transducer smaller than a cross section proximal to the electro-acoustic transducer; and
at least one tuned blade coupled to the booster, wherein the at least one blade applies flexural vibrations to the liquid or multiphasic media.

2. An ultrasonic system according to claim 1 further comprising a horn having a tip, the horn being coupled to the distal end of the booster and the tip of the horn being coupled to the at least one blade.

3. An ultrasonic system according to claim 1, wherein the electro-acoustic transducer comprises piezo-electric elements polarized in the circumferential direction, producing a torsional vibratory motion of the electro-acoustic transducer in response to the alternating electrical field applied.

4. An ultrasonic system according to claim 1, wherein,
the electro-acoustic transducer comprises piezo-electric elements polarized in the thickness direction, producing a longitudinal motion in response to the alternating electrical field applied, and
the booster is an inhomogeneous booster transforming longitudinal motion into torsional oscillation,
wherein the electro-acoustic transducer is coupled to the inhomogeneous booster, achieving a torsional or longitudinal-torsional composite vibratory motion.

5. An ultrasonic system according to claim 2, wherein
the electro-acoustic transducer comprises piezo-electric elements polarized in the thickness direction, and forms a sub-assembly with the booster, the sub-assembly producing a longitudinal motion in response to the alternating electrical field applied, and
the horn is an inhomogenous horn,
wherein the sub-assembly is coupled to the inhomogeneous horn transforming the longitudinal motion into torsional or longitudinal-torsional composite vibratory motion.

6. An ultrasonic system according to claim 1, wherein
the electro-acoustic transducer comprises magnetostrictive elements, producing a longitudinal motion in response of a magnetic field induced by the alternating electrical field, and,
the booster is an inhomogenous booster,
wherein electro-acoustic transducer is coupled to the inhomogeneous booster transforming longitudinal motion into torsional or longitudinal-torsional composite vibratory motion.

7. An ultrasonic system according to claim 2, wherein
the electro-acoustic transducer comprises magnetostrictive elements, and forms a sub-assembly with the booster, the sub-assembly producing a longitudinal motion in response of a magnetic field induced by the alternating electrical field, and
the horn is an inhomogenous horn,
wherein the sub-assembly is coupled to the inhomogeneous horn transforming longitudinal motion to a torsional or longitudinal-torsional composite vibratory motion.

8. An ultrasonic system according to claim 4, wherein the inhomogeneous booster is a spiral tapered rod, or a tapered rod with a number of diagonal slits.

9. An ultrasonic system according to claim 5, wherein the inhomogeneous horn is a twisted bar, a spiral rod, or a rod with a number of diagonal slits.

10. An ultrasonic system according to claim 2, wherein the horn has several half-wavelengths long in order that a plurality of tuned blades -may be connected together at the horn anti-nodes.

11. An ultrasonic system of claim 1, wherein the at least one blade behaves like a cantilever beam whose tuned length is equal to integer multiples of the flexural half-wavelength.

12. An ultrasonic system according to claim 2, wherein the blades and horn are machined from one piece of metal.

13. An ultrasonic system according to claim 2, wherein the at least one blade is welded to the horn.

14. An ultrasonic system according to claim 2, wherein the at least one blade is coupled to the horn via at least one groove joint machined at the horn tip.

15. An ultrasonic system according to claim 2, further comprising a motor coupled to the ultrasonic transducer rotating the ultrasonic transducer together with the booster, the horn and the al least one flexural blade.

16. An ultrasonic system according to claim 2, wherein the at least one blade is mounted diagonally respect to the horn axis thus to be excited in a flexural mode through the longitudinal-torsional produced at the horn tip.

17. (canceled)

18. An ultrasonic system according to claim 6, wherein the inhomogeneous booster is a spiral tapered rod, or a tapered rod with a number of diagonal slits.

19. An ultrasonic system according to claim 7, wherein the inhomogeneous horn is a twisted bar, a spiral rod, or a rod with a number of diagonal slits.

20. An ultrasonic system according to according to claim 1, wherein the blades and booster are machined from one piece of metal.

21. An ultrasonic system according to claim 1, wherein the at least one blade is welded to the booster.

22. An ultrasonic system according to claim 1, wherein the at least one blade is coupled to the booster via at least one groove joint machined at the booster tip.

23. An ultrasonic system according to claim 1, further comprising a motor coupled to the ultrasonic transducer rotating the ultrasonic transducer together with the booster, and the at least one flexural blade.

24. A method for ultrasonic processing of liquid and multiphasic media contained in a reactor comprising the steps of:
providing an ultrasonic system comprising:
a source of alternating electrical field;
an electro-acoustic transducer connected to the source of alternating electrical field;
a booster connected to the electrical acoustic transducer with a cross section distal to the electro-acoustic transducer smaller than a cross section proximal to the electro-acoustic transducer; and
at least one tuned blade coupled to the booster, wherein the at least one blade applies flexural vibrations in the liquid or multiphasic media;
locating the at least one blade of the system in the reactor; and
actuating the ultrasonic system by applying an alternating electrical field to the electro-acoustic transducer.
